(19) United States
(12) Patent Application Publication
(10) Pub. No.: US 2024/0267975 A1
(43) Pub. Date: Aug. 8, 2024

(54) SMALL DATA TRANSMISSION

(71) Applicant: Nokia Technologies Oy, Espoo (FI)

(72) Inventors: Deepa MALAPATI RAVINDRAIAH, Bangalore (IN); Philippe GODIN, Massy (FR); Sankaran BALASUBRAMANIAM, Bangalore (IN); Ethiraj ALWAR, Bangalore (IN); Rajesh BANDA, Bangalore (IN)

(21) Appl. No.: 18/425,288

(22) Filed: Jan. 29, 2024

(30) Foreign Application Priority Data
Feb. 3, 2023 (IN) 202341007026

(51) Int. Cl. H04W 76/20; H04W 76/12; H04W 76/19

(52) U.S. Cl. CPC H04W 76/20; H04W 76/12; H04W 76/19

(57) ABSTRACT

Embodiments of the present disclosure relate to small data transmission (SDT). In the embodiments, a distributed unit (DU) of a network device determines that data for small data transmission (SDT), from a terminal device comprises data for at least one signaling radio bearer (SRB), without comprising data for a data radio bearer, DRB. The DU transmits, to a control plane (CP) of a central unit (CU) of the network device, an indication that the data for SDT is associated with the at least one SRB, and without being associated with a DRB. In this way, the SDT can be optimized.

### FIELD

Various example embodiments relate to the field of telecommunication and in particular, to methods, devices, apparatuses, and computer readable storage media for small data transmission (SDT).

### BACKGROUND

With the development of communications technologies, there is a new network architecture developed to split functions of a base station in a radio access network for improving flexibility of deployment. Some functions of the base station are deployed on a central unit (CU), and other functions are deployed on a distributed unit (DU). For example, the CU may be responsible for some higher-level protocol stack functions and the DU may be responsible for lower-level protocol stack functions.

Besides, to avoid signaling overhead and delay associated with the state transition of a terminal device, such as user equipment (UE) from an inactive state (for example, a radio resource control (RRC) inactive state, also denoted as RRC_inactive state) to a connected state (for example, an RRC_connected state), a transmission scheme called SDT has been proposed to facilitate data transmission. In the SDT procedure, data interaction between a base station and UE may be achieved, while the UE is still in the RRC_inactive state during the data transmission. However, enhancements on SDT are still in further investigation.

### SUMMARY

In general, example embodiments of the present disclosure provide a solution related to SDT.

In a first aspect, there is provided a distributed unit (DU) of a network device. The DU comprises at least one processor and at least one memory storing instructions that, when executed by the at least one processor, cause the DU at least to: determine that data for small data transmission (SDT) from a terminal device comprises data for at least one signaling radio bearer (SRB) without comprising data for a data radio bearer (DRB); and transmit, to a control plane (CP) of a central unit (CU) of the network device, an indication that the data for SDT is associated with the at least one SRB, and without being associated with a DRB.

In a second aspect, there is provided a control plane (CP) of a centralized unit (CU) of a network device. The CP comprises at least one processor and at least one memory storing instructions that, when executed by the at least one processor, cause the CP at least to: receive, from a distributed unit (DU) of the network device, an indication that data for small data transmission (SDT) from a terminal device is associated with at least one signaling radio bearer (SRB) and without being associated with a data radio bearer (DRB); and transmit, to the DU, a context request message for setting up the at least one SRB without setting up a DRB.

In a third aspect, there is provided a distributed unit (DU) of a network device. The DU comprises at least one processor and at least one memory storing instructions that, when executed by the at least one processor, cause the DU at least to: determine that data for small data transmission (SDT) from a terminal device is associated with a subset of data radio bearers (DRBs) configured for the SDT; and transmit, to a control plane (CP) of a central unit (CU) of the network device, an indication of the subset of DRBs to be setup.

In a fourth aspect, there is provided a control plane (CP) of a centralized unit (CU) of a network device. The CP comprises at least one processor and at least one memory storing instructions that, when executed by the at least one processor, cause the CP at least to: receive, from a distributed unit (DU) of the network device, an indication of a subset of data radio bearers (DRBs) configured for a small data transmission (SDT) for a terminal device; and transmit, to the DU, a context request message including at least one DRB configured for the SDT to be setup corresponding to the received subset of DRBs.

In a fifth aspect, there is provided a user plane (UP) of a centralized unit (CU) of a network device. The UP comprises at least one processor and at least one memory storing instructions that, when executed by the at least one processor, cause the UP at least to: receive, from a control plane (CP) of the CU, a request for a bearer context modification, the request comprising an indication of at least one of a first list of data radio bearers (DRBs) to be resumed or a second list of DRBs to remain in a suspended state; and perform, based on the indication, a bearer context modification procedure to resume the first list of DRBs.

In a sixth aspect, there is provided a method implemented at a distributed unit (DU) of a network device. The method comprises determining that data for small data transmission (SDT) from a terminal device comprises data for at least one signaling radio bearer (SRB) without comprising data for a data radio bearer (DRB); and transmitting, to a control plane (CP) of a central unit (CU) of the network device, an indication that the data for SDT is associated with the at least one SRB, and without being associated with a DRB.

In a seventh aspect, there is provided a method implemented at a control plane (CP) to a centralized unit (CU) of a network device. The method comprises receiving, from a distributed unit (DU) of the network device, an indication that data for small data transmission (SDT) from a terminal device is associated with at least one signaling radio bearer (SRB) and without being associated with a data radio bearer (DRB); and transmitting, to the DU, a context request message for setting up the at least one SRB without setting up a DRB.

In an eighth aspect, there is provided a method implemented at a distributed unit (DU) of a network device. The method comprises determining that data for small data transmission (SDT) from a terminal device is associated with a subset of data radio bearers (DRBs) configured for the SDT; and transmitting, to a control plane (CP) of a central unit (CU) of the network device, an indication of the subset of DRBs to be setup.

In a ninth aspect, there is provided a method implemented at a control plane (CP) of a centralized unit (CU) of a network device. The method comprises receiving, from a distributed unit (DU) of the network device, an indication of a subset of data radio bearers (DRBs) configured for a small data transmission (SDT) for a terminal device; and transmitting, to the DU, a context request message including at least one DRB configured for the SDT to be setup corresponding to the received subset of DRBs.

In a tenth aspect, there is provided a method implemented at user plane (UP) of a centralized unit (CU) of a network device. The method comprises receiving, from a control plane (CP) of the CU, a request for a bearer context modification, the request comprising an indication of at least one of a first list of data radio bearers (DRBs) to be resumed or a second list of DRBs to remain in a suspended state; and performing, based on the indication, a bearer context modification procedure to resume the first list of DRBs.

In an eleventh aspect, there is provided an apparatus. The apparatus comprises means for determining, at a distributed unit (DU) of a network device, that data for small data transmission (SDT) from a terminal device comprises data for at least one signaling radio bearer (SRB) without comprising data for a data radio bearer (DRB); and means for transmitting, to a control plane (CP) of a central unit (CU) of the network device, an indication that the data for SDT is associated with the at least one SRB, and without being associated with a DRB.

In a twelfth aspect, there is provided an apparatus. The apparatus comprises means for receiving, at a control plane (CP) of a central unit (CU) of a network device, from a distributed unit (DU) of the network device, an indication that data for small data transmission (SDT) from a terminal device is associated with at least one signaling radio bearer (SRB) and without being associated with a data radio bearer (DRB); and means for transmitting, to the DU, a context request message for setting up the at least one SRB without setting up a DRB.

In a thirteenth aspect, there is provided an apparatus. The apparatus comprises means for determining, at a distributed unit (DU) of a network device, that data for small data transmission (SDT) from a terminal device is associated with a subset of data radio bearers (DRBs) configured for the SDT; and means for transmitting, to a control plane (CP) of a central unit (CU) of the network device, an indication of the subset of DRBs to be setup.

In a fourteenth aspect, there is provided an apparatus. The apparatus comprises means for receiving, at a control plane (CP) of a central unit (CU) of a network device, from a distributed unit (DU) of the network device, an indication of a subset of data radio bearers (DRBs) configured for a small data transmission (SDT) for a terminal device; and means for transmitting, to the DU, a context request message including at least one DRB configured for the SDT to be setup corresponding to the received subset of DRBs.

In a fifteenth aspect, there is provided an apparatus. The apparatus comprises means for receiving, at a user plane (UP) of a central unit (CU) of a network device, from a control plane (CP) of the CU, a request for a bearer context modification, the request comprising an indication of at least one of a first list of data radio bearers (DRBs) to be resumed or a second list of DRBs to remain in a suspended state; and means for performing, based on the indication, a bearer context modification procedure to resume the first list of DRBs.

In a sixteenth aspect, there is provided a non-transitory computer readable medium comprising program instructions for causing an apparatus to perform at least the method according to any one of the above sixth to tenth aspects.

In a seventeenth aspect, there is provided a computer program comprising instructions, which, when executed by an apparatus, cause the apparatus at least to perform at least the method according to any one of the above sixth to tenth aspects.

In an eighteen aspect, there is provided a distributed unit (DU) of a network device. The DU comprises determining circuitry configured to determining that data for small data transmission (SDT) from a terminal device comprises data for at least one signaling radio bearer (SRB) without comprising data for a data radio bearer (DRB); and transmitting circuitry configured to transmit, to a control plane (CP) of a central unit (CU) of the network device, an indication that the data for SDT is associated with the at least one SRB, and without being associated with a DRB.

In a nineteenth aspect, there is provided a control plane (CP) of a centralized unit (CU) of a network device. The CP comprises receiving circuitry configured to receive, from a distributed unit (DU) of the network device, an indication that data for small data transmission (SDT) from a terminal device is associated with at least one signaling radio bearer (SRB) and without being associated with a data radio bearer (DRB); and transmitting circuitry configured to transmit, to the DU, a context request message for setting up the at least one SRB without setting up a DRB.

In a twentieth aspect, there is provided a distributed unit (DU) of a network device. The DU comprises determining circuitry configured to determine that data for small data transmission (SDT) from a terminal device is associated with a subset of data radio bearers (DRBs) configured for the SDT; and transmitting circuitry configured to transmit, to a control plane (CP) of a central unit (CU) of the network device, an indication of the subset of DRBs to be setup.

In a twenty-first aspect, there is provided a control plane (CP) of a centralized unit (CU) of a network device. The CU comprises receiving circuitry configured to receive, from a distributed unit (DU) of the network device, an indication of a subset of data radio bearers (DRBs) configured for a small data transmission (SDT) for a terminal device; and transmitting circuitry configured to transmit, to the DU, a context request message including at least one DRB configured for the SDT to be setup corresponding to the received subset of DRBs.

In a twenty-second aspect, there is provided a user plane (UP) of a centralized unit (CU) of a network device. The UP comprises receiving circuitry configured to receive, from a control plane (CP) of the CU, a request for a bearer context modification, the request comprising an indication of at least one of a first list of data radio bearers (DRBs) to be resumed or a second list of DRBs to remain in a suspended state; and performing circuitry configured to perform, based on the indication, a bearer context modification procedure to resume the first list of DRBs.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example environment in which example embodiments of the present disclosure can be implemented;

FIG. 1B illustrates an example radio resource control (RRC) state machine related to some example embodiments of the present disclosure:

FIG. 1C illustrates an example 4-step random access (RA) process related to some example embodiments of the present disclosure:

FIG. 1D illustrates an example 2-step random access (RA) process related to some example embodiments of the present disclosure:

FIG. 1E illustrates an example configured grant (CG) based SDT process related to some example embodiments of the present disclosure;

FIG. 2 illustrates a signaling flow between a DU and a CP of a CU of a network device according to some example embodiments of the present disclosure;

FIG. 3 illustrates a signaling flow among a DU, a CP of a CU, and a UP of the CU of a network device according to some example embodiments of the present disclosure;

FIG. 4 illustrates an example SDT process according to some example embodiments of the present disclosure:

FIG. 5 illustrates an example SDT process according to some other example embodiments of the present disclosure;

FIG. 6 illustrates a flowchart of a method implemented at a DU of a network device according to some embodiments of the present disclosure:

FIG. 7 illustrates a flowchart of a method implemented at a CP of a CU of a network device according to some embodiments of the present disclosure;

FIG. 8 illustrates a flowchart of a method implemented at a DU of a network device according to some embodiments of the present disclosure:

FIG. 9 illustrates a flowchart of a method implemented at a CP of a CU of a network device according to some embodiments of the present disclosure;

FIG. 10 illustrates a flowchart of a method implemented at a UP of a CU of a network device according to some embodiments of the present disclosure;

FIG. 11 illustrates a simplified block diagram of a device that is suitable for implementing some example embodiments of the present disclosure; and

FIG. 12 illustrates a block diagram of an example of a computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, 5G advance communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As stated above, SDT is a procedure that allows the transmission of small and infrequent traffic without the need to move to an RRC_connected state. This will reduce the unnecessary signaling overhead, and optimize the UE power, signaling, and latency.

Specific examples of the small and infrequent data traffic include the following use cases:
Smartphone applications:
   Traffic from instant messaging services (SMS, whatsapp, QQ, wechat, etc.)
   Heart-beat/keep-alive traffic from IM/email clients and other apps
   Push notifications from various applications
Non-smartphone applications:
   Traffic from wearables (periodic positioning information etc.)
   Sensors (industrial wireless sensor networks transmitting temperature, pressure readings periodically or in an event-triggered manner etc.)
   Smart meters and smart meter networks sending periodic meter readings

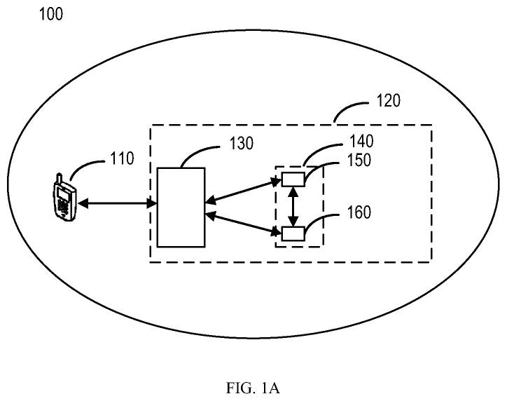

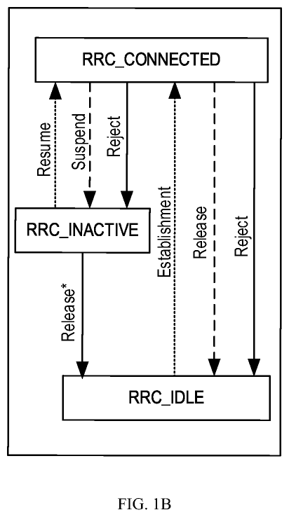

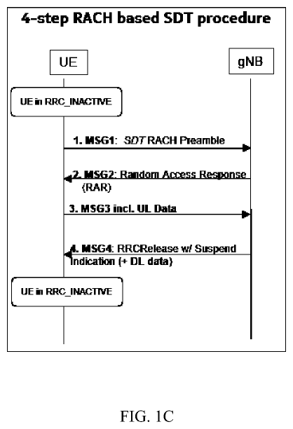

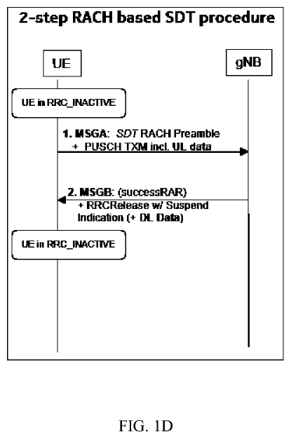

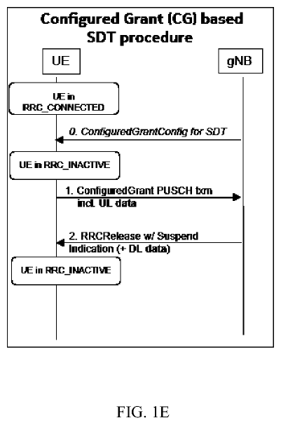

SDT is enabled on a radio bearer basis and is initiated by the UE only if less than a configured amount of uplink data awaits transmission across all radio bearers for which SDT is enabled, downlink reference signal received power (RSRP) is above a configured threshold and a valid SDT resource is available. SDT procedure is initiated with either a transmission over a random access channel (RACH) (configured via system information) or over Type 1 configured grant (CG) resources (configured via dedicated signaling in an RRCRelease message), which will be described in detail with reference to FIGS. 1C to 1E. For random access, the gNB may configure 2-step and/or 4-step RA resources for SDT.

3rd Generation Partnership Project (3GPP) release 17 (Rel-17) has introduced mobile-originated small data transmissions (MO-SDT). In the current Rel-17 MO-SDT procedure, all the SRBs and DRBs configured with SDT are resumed whenever some SDT data has to be sent from the UE to the gNB.

Inventors noticed that, as SDT data may contain signaling information or user data, if SDT data includes both signaling information and user data, the resuming of SRB and DRBs configured for SDT is required. However, the resuming of DRBs at the gNB is an unnecessary overhead on the network side if the SDT data to be sent includes only signaling information. Similarly, if the SDT data to be sent only relates to a subset of the DRBs configured for SDT, still all SDT DRBs will be uselessly resumed at gNB as per current specification. This is inefficient from a network perspective.

In view of the above, enhancements on the SDT procedure shall be considered. Therefore, there is a need for an improved SDT procedure with the consideration of signaling overhead.

According to some embodiments of the present disclosure, there is provided a scheme for SDT. With this scheme, a DU of a network device determines that data for SDT from a terminal device comprises data for at least one SRB, without comprising data for a DRB. Then, the DU transmits, to a CP of a CU of the network device, an indication that the data for SDT is associated with the at least one SRB, and without being associated with a DRB. Moreover, the CP transmits, to the DU, a context request message for setting up the at least one SRB without setting up a DRB. Moreover, the CP of the CU refrains from requesting the UP of the CU to resume some DRBs.

This scheme optimizes the SDT procedure by avoiding setting up DRBs configured for SDT at the network side when SDT data comprise signaling information only. In this way, it is allowed to reduce the signaling overhead, and thus improve communication efficiency. Also the SDT procedure is further optimized by the CP of the CU refraining from sending signaling to the UP of the CU to resume some DRBs, in contrast to what it currently does.

According to some other embodiments of the present disclosure, there is provided another scheme for SDT. With this scheme, a DU of a network device determines that data for SDT from a terminal device is associated with a subset of DRBs configured for the SDT. Then, the DU transmits, to a CP of a CU of the network device, an indication of the subset of DRBs to be setup. Moreover, the CP transmits, to the DU, a context request message including at least one DRB configured for the SDT to be setup corresponding to the received subset of DRBs. In addition, the CP transmits, to a UP of the CU, a further request for a bearer context modification, the further request comprising an indication of at least one of a list of DRBs to be resumed or a further list of DRBs to remain in a suspended state.

This scheme optimizes the SDT procedure by avoiding setting up additional DRBs configured for SDT at the network side when SDT data is associated with a subset of DRBs only. In this way, it is allowed to reduce the signaling overhead, and thus improve communication efficiency.

It is to be understood that the “SDT” or “SDT procedure” as used herein is not limited to the SDT procedure specified in the current 3GPP protocol, it may also refer to a similar communication procedure with similar functions, purposes, or effects in a 3GPP protocol to be developed in the future, or any other communication protocols either currently known or to be developed in the future.

Principle and embodiments of the present disclosure will be described in detail below with reference to the accompanying drawings. Reference is first made to FIG. 1, which illustrates an example environment 100 in which example embodiments of the present disclosure can be implemented.

The environment 100, which may be a part of a communication network, comprises a terminal device 110 and a network device 120 communicating with each other or with other devices via each other.

The network device 120 may comprise a DU 130 and a CU 140. For example, the DU 130 may be under the control of the CU 140. Some functions of the network device 120 may be deployed on the CU 140, and other functions may be deployed on the DU 130. For example, the CU 140 may be responsible for some higher-level protocol stack functions and the DU 130 may be responsible for lower-level protocol stack functions. The CU 140 may comprise a CP 150 and a UP 160 connecting via an E1 interface.

In the environment 100, the terminal device 110 and the network device 120 can communicate data and control information with each other. A link from the network device 120 to the terminal device 110 is referred to as a downlink (DL), while a link from the terminal device 110 to the network device 120 is referred to as an uplink (UL).

It is to be understood that the environment 100 shown in FIG. 1A is only for the purpose of illustration without suggesting any limitation as to the scope of the disclosure. For example, while FIG. 1A depicts the terminal device 110 as a mobile phone, the terminal device 110 may be any type of user equipment.

It is to be understood that the number of devices and their connection relationships, structures and types as shown in FIG. 1A are only for the purpose of illustration without suggesting any limitation. The environment 100 may include any suitable number of devices adapted for implementing embodiments of the present disclosure.

The communications in the environment 100 may follow any suitable communication standards or protocols, which are already in existence or to be developed in the future, such as universal mobile telecommunications system (UMTS), long term evolution (LTE), LTE-advanced (LTE-A), the fifth generation (5G) new radio (NR), wireless fidelity (Wi-Fi) and worldwide interoperability for microwave access (WiMAX) standards, and employs any suitable communication technologies, including, for example, multiple-input multiple-output (MIMO), orthogonal frequency division multiplexing (OFDM), time division multiplexing (TDM), frequency division multiplexing (FDM), code division multiplexing (CDM), bluetooth, ZigBee, and machine type communication (MTC), enhanced mobile broadband (eMBB), massive machine type communication (mMTC), ultra-reliable low latency communication (URLLC), carrier aggregation (CA), dual connectivity (DC), and new radio unlicensed (NR-U) technologies.

FIG. 1B illustrates an example RRC state machine related to some example embodiments of the present disclosure. Currently, three types of RRC states have been defined for the terminal device, that is, an RRC_connected state, an RRC_inactive state and an RRC_idle state.

For data transfer, an RRC resume message may be transmitted to enable the terminal device to transition from the RRC_inactive state to the RRC_connected state, or an RRC establishment message may be transmitted to enable the terminal device to transition from the RRC_idle state to the RRC_connected state. For an expire of the RRC state transition timer or data inactivity, an RRC suspend message may be transmitted to enable the terminal device to transition from the RRC_connected state to the RRC_inactive state, or an RRC release message may be transmitted to enable the terminal device to transition from the RRC_connected state to the RRC_idle state. For overload or failure cases, an RRC reject message may be transmitted to enable the terminal device to transition from the RRC_connected state to the RRC_inactive state or the RRC_idle state, or an RRC release message may be transmitted to enable the terminal device to transition from the RRC_inactive state to the RRC_idle state.

FIG. 1C illustrates an example 4-step random access (RA) process related to some example embodiments of the present disclosure. As shown in FIG. 1C, at step 1, the UE transmits a message 1 (MSG1) with an SDT RACH preamble to the gNB. At step 2, the gNB transmits a random access response (RAR) to the UE. At step 3, the UE transmits a message 3 (MSG3) with uplink data to the gNB. At step 4, the gNB transmits an RRCRelease message with a suspend indication and optional downlink data to the UE.

FIG. 1D illustrates an example 2-step random access (RA) process related to some example embodiments of the present disclosure. As shown in FIG. 1D, at step 1, the UE transmits a message A (MSGA) with an SDT RACH preamble and optional uplink data to the gNB. At step 2, the gNB transmits a message B (MSGB) with RAR, an RRCRelease message with a suspend indication, and optional downlink data to the UE.

FIG. 1E illustrates an example configured grant (CG) based SDT process related to some example embodiments of the present disclosure. As shown in FIG. 1E, the UE is in an RRC_connected state. At step 1, at step 0, the gNB transmits a ConfiguredGrantConfig for SDT to the UE. The UE transitions to an RRC_inactive state. At step 1, the UE transmits a ConfiguredGrant physical uplink shared channel (PUSCH) transmission with uplink data to the gNB. At step 2, the gNB transmits an RRCRelease message with a suspend indication and optional downlink data to the UE. During the SDT, the UE remains the RRC_inactive state.

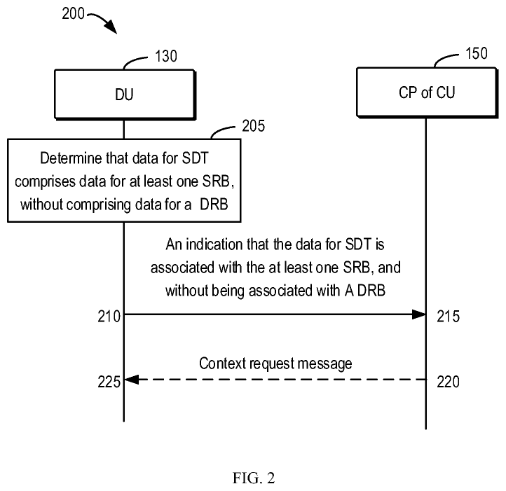

FIG. 2 illustrates a signaling flow between the DU 130 and the CP 150 of the CU 140 of the network device 120 according to some example embodiments of the present disclosure. For the purpose of discussion, the signaling flow 200 will be described with reference to FIG. 1A.

As shown in FIG. 2, the DU 130 determines (205) that data for SDT from the terminal device 110 comprises data for at least one SRB, without comprising data for a DRB. For example, based on the BSR (Buffer Status Report) or informations contained in the MAC PDU containing the RRCResumeRequest message or the RRC Resume Request itself with uplink signaling for SDT from the terminal device 110, the DU 130 may detect that the incoming data for SDT may only comprise signaling information. The signaling information may comprise, for example, an RRC signaling message, a non-access stratum (NAS) signaling message, a short message service (SMS) message, etc. In other words, for example, based on the BSR (Buffer Status Report) or informations contained in the MAC PDU containing the RRCResumeRequest message or the RRC Resume Request itself from the terminal device 110, the DU 130 may determine that the incoming data for SDT only involves one or more SRBs.

Then, the DU 130 transmits (210), to the CP 150 of the CU 140, an indication that the data for SDT is associated with the at least one SRB, and without being associated with a DRB. On the receiving side, the CP 150 of the CU 140 receives (215) the indication from the DU 130, and thus determines that there is no need to set up one or more DRBs allocated for the SDT in the DU 130 and no need to contact the CU UP 160 to resume the DRBs in the CU UP 160.

For example, the indication may be transmitted in an Initial UL RRC message transfer message. In this case, as an example, the indication may be a part of assistance information within the Initial UL RRC message transfer message.

As shown in FIG. 2, the CP 150 of the CU 140 may transmit (220), to the DU 130, a context request message for setting up the at least one SRB without setting up a DRB. Accordingly, the DU 130 may receive (225) the context request message from the CP 150 of the CU 140. For example, the context request message may comprise an F1 UE Context Setup Request message, and in this case, the CP 150 of the CU 140 may trigger the F1 UE Context Setup Request message in which it only sets up one or more SRBs.

For example, the context request message may request to set up one or more SRBs only. For the reason no DRB is to be setup, the context request message may not comprise an uplink tunnel endpoint identifier (TEID) for a DRB.

Then, the DU 130 may transmit, to the CP 150 of the CU 140, a context response message for setting up the at least one SRB without setting up a DRB. The context response message may only be associated with one or more SRBs to be setup, and thus may not comprise a downlink TEID for a DRB.

In this case, for the reason that no DRB is to be set up, the CP 150 of the CU 140 may refrain from contacting the UP 160 of the CU 140 to resume a DRB upon receiving the indication from the DU 130. The CP 150 of the CU 140 may refrain from triggering a bearer context modification procedure towards the UP 160 of the CU 140 in order to keep the DRBs configured for SDT in a suspended state. That is, the CP 150 of the CU 140 may refrain from triggering the E1 Bearer Context Modification procedure towards the UP 160 of the CU 140 to resume the DRBs configured for SDT.

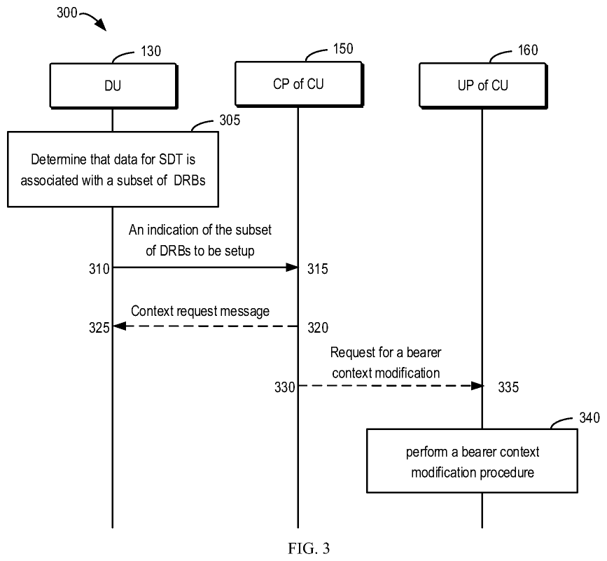

FIG. 3 illustrates a signaling flow among the DU 130, the CP 150 of the CU 140 and the UP 160 of the CU 140 of the network device 120 according to some example embodiments of the present disclosure. For the purpose of discussion, the signaling flow 300 will be described with reference to FIG. 1A.

As shown in FIG. 3, the DU 130 determines (305) that data for SDT from the terminal device 110 is associated with a subset of DRBs configured for the SDT. For example, based on the BSR (Buffer Status Report) or informations contained in the MAC PDU containing the RRCResumeRequest message or the RRC Resume Request itself with uplink data for SDT from the terminal device 110, the DU 130 may detect that the incoming data for SDT only involves a subset of DRBs configured for the SDT, that is, part of all DRBs configured for the SDT. In other words, for example, based on the BSR (Buffer Status Report) or informations contained in the MAC PDU containing the RRCResumeRequest message or the RRC Resume Request itself from the terminal device 110, the DU 130 may determine that the incoming data for SDT only involves the subset of DRBs that are configured for SDT.

Then, the DU 130 transmits (310), to the CP 150 of the CU 140, an indication of the subset of DRBs to be setup. On the receiving side, the CP 150 of the CU 140 receives (315) the indication from the DU 130, and thus determines that there is no need to set up all DRBs allocated for the SDT, but there is only a need to set up the subset of DRBs only.

As an example, the DU 130 may transmit, to the CP 150 of the CU 140, a list of DRB identifiers (IDs), which comprises IDs of the subset of DRBs. As another example, the DU 130 may transmit, to the CP 150 of the CU 140, a list of remaining DRB IDs, which comprises IDs of remaining DRBs determined based on all DRBs excluding the subset of DRBs. In this case, the CP 150 of the CU 140 may determine the subset of DRBs to be setup based on a list of all DRB IDs or the received list of remaining DRB IDs.

For example, the indication may be transmitted in an Initial UL RRC message transfer message. In this case, as an example, the indication may be a part of assistance information within the Initial UL RRC message transfer message.

As shown in FIG. 3, the CP 150 of the CU 140 may transmit (320), to the DU 130, a context request message including at least one DRB configured for the SDT to be setup corresponding to the received subset of DRBs, for setting up the subset of DRBs. Accordingly, the DU 130 may receive (325) the context request message from the CP 150 of the CU 140.

For example, the context request message may request to set up one or more SRBs and the subset of DRBs. The context request message may comprise at least one TEID for the subset of DRBs.

Then, the DU 130 may transmit, to the CP 150 of the CU 140, a context response message for setting up the subset of DRBs. The context response message may comprise at least one downlink TEID for the subset of DRBs.

As shown in FIG. 3, the CP 150 of the CU 140 may transmit (330), to the UP 160 of the CU 140, a further request for a bearer context modification. Accordingly, the UP 160 of the CU 140 may receive (335) the bearer context modification from the CP 150 of the CU 140. For example, the CP 150 of the CU 140 may trigger an E1 Bearer Context modification procedure towards the UP 160 of the CU 140 newly including the subset of DRBs received from the DU 130 which are to be resumed, for example, including IDs of the subset of DRBs.

As an example, the further request may comprise an indication of a list of DRBs to be resumed. For example, the list of DRBs to be resumed may comprise the received subset of DRBs. That is, the list of DRBs to be resumed may contain DRBs previously configured as SDT DRBs for the terminal device 110. Alternatively or additionally, the further request may comprise an indication of a further list of DRBs to remain in a suspended state. As an example, the list of DRBs to remain in a suspended state may comprise DRBs configured for the SDT for the terminal device 110 except the received subset of DRBs. For example, the list of DRBs to remain in a suspended state may comprise all DRBs configured for the SDT excluding the subset of DRBs. That is, the list of DRBs to remain in a suspended state may contain DRBs previously configured as SDT DRBs for the terminal device 110.

Then, the UP 160 of the CU 140 performs (340) a bearer context modification procedure to resume the first list of DRBs, based on the indication. For example, the UP 160 of the CU 140 may modify the bearer context associated with the subset of DRBs.

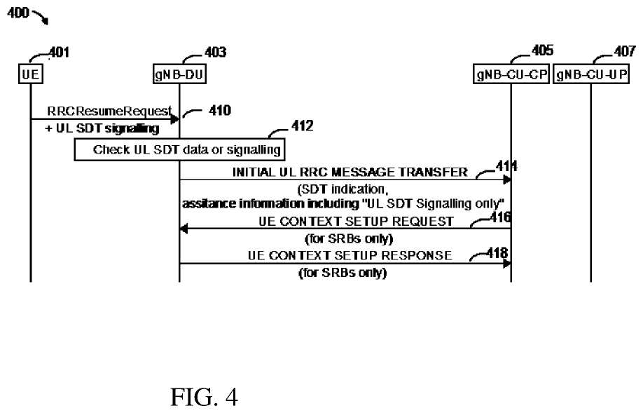

FIG. 4 illustrates an example SDT process according to some example embodiments of the present disclosure. It would be appreciated that the process flow 400 may be considered as an example of the signaling flow 200 as shown in FIG. 2. Accordingly, the UE 401 may be an example of the terminal device 110, the DU of the gNB (also denoted as gNB-DU) 403 may be an example of the DU 130 of the network device 120, the CP of the CU of the gNB (also denoted as gNB-CU-CP) 405 may be an example of the CP 150 of the CU 140 of the network device 120, and the UP of the CU of the gNB (also denoted as gNB-CU-UP) 407 may be an example of the UP 160 of the CU 140 of the network device 120.

As shown in FIG. 4, at 410, the UE 401 transmits an RRCResumeRequest message with UL SDT signaling to the gNB-DU 403. At 412, the gNB-DU 403 checks whether there is user data or signaling. The gNB-DU 403 may identify that SDT data consists of signaling information only. Then, at 414, the gNB-DU 403 sends a new “UL SDT signaling only” indicator along with the SDT indication in the Initial UL RRC Message Transfer message to the gNB-CU-CP 405. This new indicator may be included as part of the existing assistance information information element (IE). Then, the gNB-CU-CP 405 determines, from the received “UL SDT signaling only” indicator, that the SDT data request consists of only signaling and there is no need of setting up the DRBs configured for SDT in the gNB-DU 403.

At 416, the gNB-CU-CP 405 triggers the UE context setup procedure in which it only includes a request for setting up SRBs, by transmitting, to the gNB-DU 403, a UE context setup request message for setting up SRBs. It does not include TEIDs since the DRBs configured for SDT shall not be set up. At 418, the gNB-DU 403 transmits a UE context setup response for setting up SRBs to the gNB-CU-CP 405. In this case, the gNB-CU-CP 405 refrains from triggering the bearer context modification procedure towards the gNB-CU-UP 407 in order to keep the DRBs configured for SDT in a suspended state in the gNB-CU-UP 407.

All operations and features as described above with reference to FIG. 2 are likewise applicable to the process 400 and have similar effects. For the purpose of simplification, the details will be omitted.

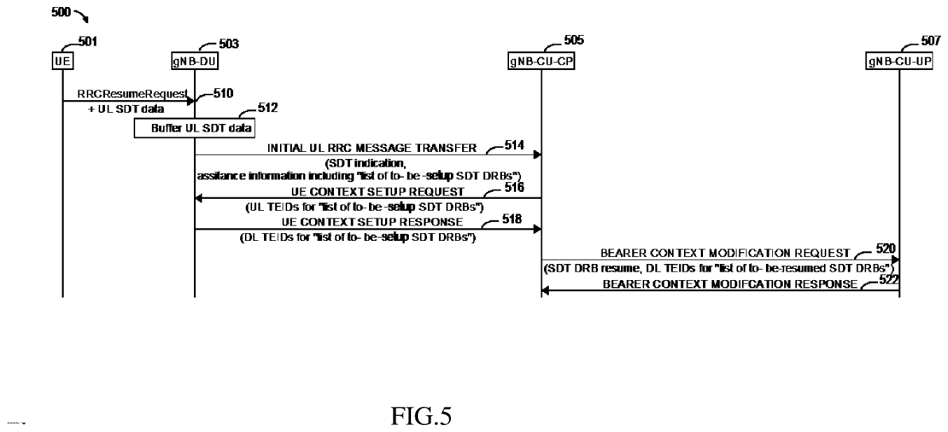

FIG. 5 illustrates an example SDT process according to some other example embodiments of the present disclosure. It would be appreciated that the process flow 500 may be considered as an example of the signaling flow 300 as shown in FIG. 3. Accordingly, the UE 501 may be an example of the terminal device 110, the DU of the gNB (also denoted as gNB-DU) 503 may be an example of the DU 130 of the network device 120, the CP of the CU of the gNB (also denoted as gNB-CU-CP) 505 may be an example of the CP 150 of the CU 140 of the network device 120, and the UP of the CU of the gNB (also denoted as gNB-CU-UP) 507 may be an example of the UP 160 of the CU 140 of the network device 120.

As shown in FIG. 5, at 510, the UE 501 transmits an RRCResumeRequest message with UL SDT data to the gNB-DU 503. At 512, the gNB-DU 503 buffers the UL SDT data. Then, the gNB-DU 503 may identify that the UL SDT data only involves a subset of the DRBs among the DRBs configured for SDT. At 514, the gNB-DU 503 sends a new “list of to-be-setup SDT DRBs” IE along with the SDT indication in the Initial UL RRC Message Transfer message to gNB-CU-CP 505. This new IE may be included as part of the existing assistance information IE. The “list of to-be-setup SDT DRBs” may comprise the subset of the DRBs. The gNB-CU-CP 505 may determine, from the received new “list of to-be-setup SDT DRBs” IE, that the list of to-be-setup DRBs consists of only a subset of the DRBs configured for SDT.

At 516, the gNB-CU-CP 505 triggers the UE context setup procedure in which it includes a request for setting up of DRBs that only comprises those DRBs which correspond to the received “list of to-be-setup SDT DRBs” IE, by transmitting, to the gNB-DU 503, a UE context setup request message for setting up the list of to-be-setup SDT DRBs. It does not include TEIDs for the other DRBs configured for SDT other than the subset of DRBs. At 518, the gNB-DU 503 transmits a UE context setup response for setting up the list of to-be-setup SDT DRBs to the gNB-CU-CP 505. The gNB-CU-CP 505 may receive the DL TEIDs for the list of to-be-setup SDT DRBs”. At 520, based on the DL TEIDs received from gNB-DU 503, the gNB-CU-CP 505 triggers the bearer context modification procedure towards the gNB-CU-UP 507 in which it newly includes at least one of: a list of SDT DRBs to be resumed corresponding to the list of to-be-setup SDT DRBs, or a list of SDT DRBs to remain in a suspended state, by transmitting a bearer context modification request message comprising, for example, the list of to-be-setup SDT DRBs to the gNB-CU-UP 507.

All operations and features as described above with reference to FIG. 3 are likewise applicable to the process 500 and have similar effects. For the purpose of simplification, the details will be omitted.

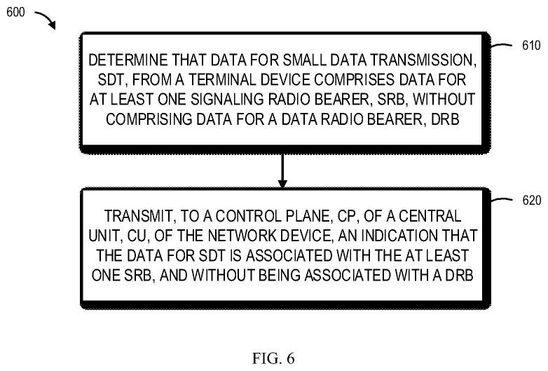

FIG. 6 illustrates a flowchart 600 of a method implemented at a DU of a network device according to some embodiments of the present disclosure. For the purpose of discussion, the method 600 will be described from the perspective of the DU 130 of the network device 120 with reference to FIG. 1A.

At block 610, the DU 130 determines that data for small data transmission, SDT, from a terminal device 110 comprises data for at least one signaling radio bearer, SRB, without comprising data for a data radio bearer, DRB. At block 620, the DU 130 transmits, to a control plane, CP 150, of a central unit, CU 140, of the network device 120, an indication that the data for SDT is associated with the at least one SRB, and without being associated with a DRB.

In some example embodiments, the indication may be transmitted in an Initial Uplink, UL, radio resource control, RRC, message transfer message. In some example embodiments, the indication may be a part of assistance information within the Initial UL RRC message transfer message.

In some example embodiments, the DU 130 may further receive, from the CP 150 of the CU 140, a context request message for setting up the at least one SRB without setting up a DRB. In some example embodiments, the context request message may not comprise an uplink tunnel endpoint identifier, TEID, for a DRB. In some example embodiments, the DU 130 may further transmit, to the CP 150 of the CU 140, a context response message for setting up the at least one SRB without setting up a DRB. In some example embodiments, the context response message may not comprise a downlink TEID for a DRB.

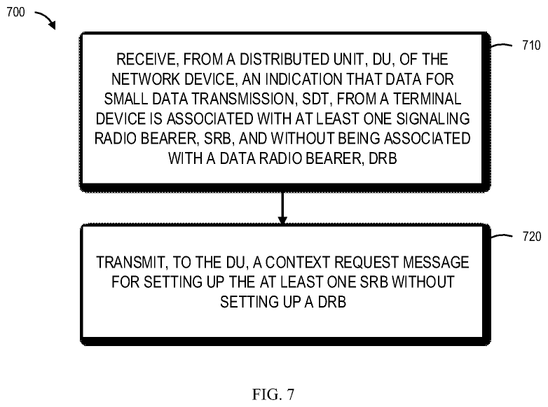

FIG. 7 illustrates a flowchart 700 of a method implemented at a CP of a CU of a network device according to some embodiments of the present disclosure. For the purpose of discussion, the method 700 will be described from the perspective of the CP 150 of the CU 140 of the network device 120 with reference to FIG. 1A.

At block 710, the CP 150 of the CU 140 receives, from a distributed unit, DU 130, of the network device 120, an indication that data for small data transmission, SDT, from a terminal device 110 is associated with at least one signaling radio bearer, SRB, and without being associated with a data radio bearer, DRB. At block 720, the CP 150 of the CU 140 transmits, to the DU 130, a context request message for setting up the at least one SRB without setting up a DRB.

In some example embodiments, the indication may be received in an Initial Uplink, UL, radio resource control, RRC, message transfer message. In some example embodiments, the indication may be a part of assistance information within the Initial UL RRC message transfer message.

In some example embodiments, the context request message may not comprise an uplink tunnel endpoint identifier, TEID for a DRB.

In some example embodiments, the CP 150 of the CU 140 may further receive, from the DU 130, a context response message for setting up the at least one SRB without setting up a DRB. In some example embodiments, the context response message may not comprise a downlink TEID for a DRB.

In some example embodiments, the CP 150 of the CU 140 may further, upon receiving the indication from the DU 130, refrain from contacting a user plane, UP 160, of the CU 140 to resume a DRB.

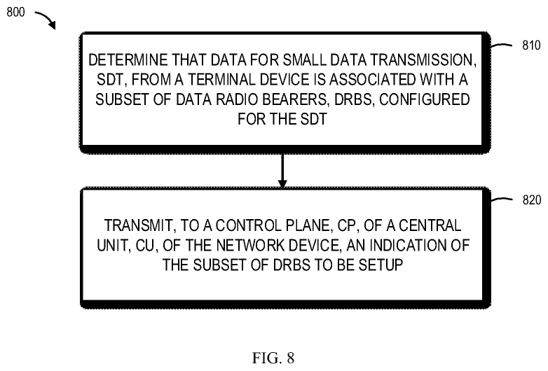

FIG. 8 illustrates a flowchart 800 of a method implemented at a DU of a network device according to some embodiments of the present disclosure. For the purpose of discussion, the method 800 will be described from the perspective of the DU 130 of the network device 120 with reference to FIG. 1A.

At block 810, the DU 130 determines that data for small data transmission, SDT, from a terminal device 110 is associated with a subset of data radio bearers, DRBs, configured for the SDT. At block 820, the DU 130 transmits, to a control plane, CP 150, of a central unit, CU 140, of the network device 120, an indication of the subset of DRBs to be setup.

In some example embodiments, the indication may be transmitted in an Initial Uplink, UL, radio resource control, RRC, message transfer message. In some example embodiments, the indication may be a part of assistance information within the Initial UL RRC message transfer message.

In some example embodiments, the DU 130 may further receive, from the CP 150 of the CU 140, a context request message for setting up the subset of DRBs. In some example embodiments, the context request message may comprise at least one uplink tunnel endpoint identifier, TEID, for the subset of DRBs. In some example embodiments, the DU 130 may further transmit, to the CP 150 of the CU 140, a context response message for setting up the subset of DRBs. In some example embodiments, the context response message may comprise at least one downlink TEID for the subset of DRBs.

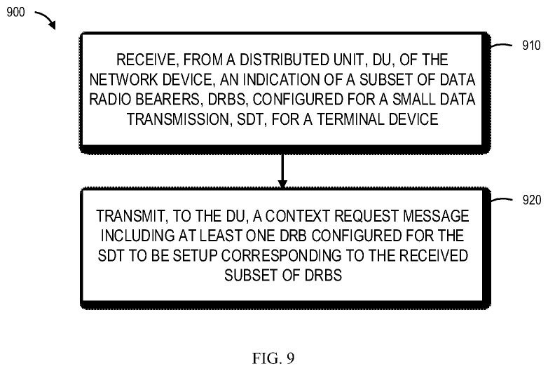

FIG. 9 illustrates a flowchart 900 of a method implemented at a CP of a CU of a network device according to some embodiments of the present disclosure. For the purpose of discussion, the method 900 will be described from the perspective of the CP 150 of the CU 140 of the network device 120 with reference to FIG. 1A.

At block 910, the CP 150 of the CU 140 receives, from a distributed unit, DU 130, of the network device 120, an indication of a subset of data radio bearers, DRBs configured for a small data transmission, SDT, for a terminal device 110. At block 920, the CP 150 of the CU 140 transmits, to the DU 130, a context request message including at least one DRB configured for the SDT to be setup corresponding to the received subset of DRBs.

In some example embodiments, the indication may be transmitted in an Initial Uplink, UL, radio resource control, RRC, message transfer message. In some example embodiments, the indication may be a part of assistance information within the Initial UL RRC message transfer message.

In some example embodiments, the context request message may comprise at least one uplink tunnel endpoint identifier, TEID, for the subset of DRBs.

In some example embodiments, the CP 150 of the CU 140 may further receive, from the DU 130, a context response message for setting up the subset of DRBs. In some example embodiments, the context response message may comprise at least one downlink TEID for the subset of DRBs.

In some example embodiments, the CP 150 of the CU 140 may further transmit, to a user plane, UP 160, of the CU 140, a further request for a bearer context modification, the further request comprising an indication of at least one of a list of DRBs to be resumed or a further list of DRBs to remain in a suspended state. In some example embodiments, the list of DRBs to be resumed may comprise the received subset of DRBs. In some example embodiments, the list of DRBs to remain in a suspended state may comprise DRBs configured for the SDT for the terminal device 110 except the received subset of DRBs.

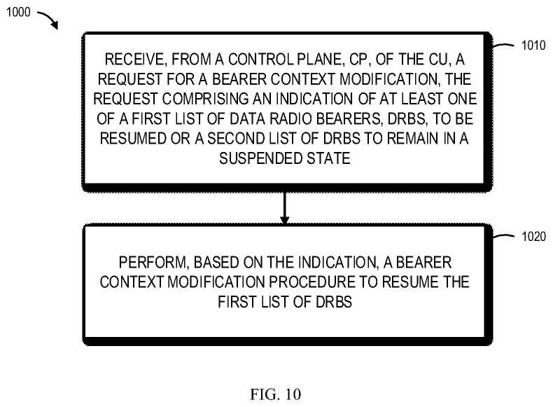

FIG. 10 illustrates a flowchart 1000 of a method implemented at a UP of a CU of a network device according to some embodiments of the present disclosure. For the purpose of discussion, the method 1000 will be described from the perspective of the UP 160 of the CU 140 of the network device 120 with reference to FIG. 1A.

At block 1010, the UP 160 of the CU 140 receives, from a control plane, CP 150, of the CU 140, a request for a bearer context modification, the request comprising an indication of at least one of a first list of data radio bearers, DRBs, to be resumed or a second list of DRBs to remain in a suspended state. At block 1020, the UP 150 of the CU 140 performs, based on the indication, a bearer context modification procedure to resume the first list of DRBs.

In some example embodiments, the first list of DRBs to be resumed or the second list of DRBs to remain in a suspended state may contain DRBs previously configured as SDT DRBs for the terminal device 110.

In some example embodiments, an apparatus capable of performing the method 600 (for example, the DU 130 of the network device 120) may comprise means for performing the respective steps of the method 600. The means may be implemented in any suitable form. For example, the means may be implemented in a circuitry or software module.

In some example embodiments, the apparatus comprises means for determining that data for small data transmission, SDT, from a terminal device comprises data for at least one signaling radio bearer, SRB, without comprising data for a data radio bearer, DRB; and means for transmitting, to a control plane, CP, of a central unit, CU, of the network device, an indication that the data for SDT is associated with the at least one SRB, and without being associated with a DRB.

In some example embodiments, the indication is transmitted in an Initial Uplink, UL, radio resource control, RRC, message transfer message. In some example embodiments, the indication is a part of assistance information within the Initial UL RRC message transfer message.

In some example embodiments, the apparatus further comprises means for receiving, from the CP of the CU, a context request message for setting up the at least one SRB without setting up a DRB. In some example embodiments, the context request message does not comprise an uplink tunnel endpoint identifier, TEID, for a DRB. In some example embodiments, the DU further comprises means for transmitting, to the CP of the CU, a context response message for setting up the at least one SRB without setting up a DRB. In some example embodiments, the context response message does not comprise a downlink TEID for a DRB.

In some example embodiments, the apparatus further comprises means for performing other steps in some embodiments of the method 600. In some embodiments, the means comprises at least one processor and at least one memory including computer program code. The at least one memory and computer program code are configured to, with the at least one processor, cause the performance of the apparatus.

In some example embodiments, an apparatus capable of performing the method 700 (for example, the CP 150 of the CU 140 of the network device 120) may comprise means for performing the respective steps of the method 700. The means may be implemented in any suitable form. For example, the means may be implemented in a circuitry or software module.

In some example embodiments, the apparatus comprises means for receiving, from a distributed unit, DU, of the network device, an indication that data for small data transmission, SDT, from a terminal device is associated with at least one signaling radio bearer, SRB, and without being associated with a data radio bearer, DRB; and means for transmitting, to the DU, a context request message for setting up the at least one SRB without setting up a DRB.

In some example embodiments, the indication is received in an Initial Uplink, UL, radio resource control, RRC, message transfer message. In some example embodiments, the indication is a part of assistance information within the Initial UL RRC message transfer message.

In some example embodiments, the context request message does not comprise an uplink tunnel endpoint identifier, TEID for a DRB.

In some example embodiments, the apparatus further comprises means for receiving, from the DU, a context response message for setting up the at least one SRB without setting up a DRB. In some example embodiments, the context response message does not comprise a downlink TEID for a DRB.

In some example embodiments, the apparatus further comprises means for, upon receiving the indication from the DU, refraining from contacting a user plane, UP, of the CU to resume a DRB.

In some example embodiments, the apparatus further comprises means for performing other steps in some embodiments of the method 700. In some embodiments, the means comprises at least one processor and at least one memory including computer program code. The at least one memory and computer program code are configured to, with the at least one processor, cause the performance of the apparatus.

In some example embodiments, an apparatus capable of performing the method 800 (for example, the DU 130 of the network device 120) may comprise means for performing the respective steps of the method 800. The means may be implemented in any suitable form. For example, the means may be implemented in a circuitry or software module.

In some example embodiments, the apparatus comprises means for determining that data for small data transmission, SDT, from a terminal device is associated with a subset of data radio bearers, DRBs, configured for the SDT; and means for transmitting, to a control plane, CP, of a central unit, CU, of the network device, an indication of the subset of DRBs to be setup. In some example embodiments, the indication is transmitted in an Initial Uplink, UL, radio resource control, RRC, message transfer message. In some example embodiments, the indication is a part of assistance information within the Initial UL RRC message transfer message.

In some example embodiments, the DU is further comprises means for receiving, from the CP of the CU, a context request message for setting up the subset of DRBs. In some example embodiments, the context request message comprises at least one uplink tunnel endpoint identifier, TEID, for the subset of DRBs. In some example embodiments, the DU further comprises means for transmitting, to the CP of the CU, a context response message for setting up the subset of DRBs. In some example embodiments, the context response message comprises at least one downlink TEID for the subset of DRBs.

In some example embodiments, the apparatus further comprises means for performing other steps in some embodiments of the method 800. In some embodiments, the means comprises at least one processor and at least one memory including computer program code. The at least one memory and computer program code are configured to, with the at least one processor, cause the performance of the apparatus.

In some example embodiments, an apparatus capable of performing the method 900 (for example, the CP 150 of the CU 140 of the network device 120) may comprise means for performing the respective steps of the method 900. The means may be implemented in any suitable form. For example, the means may be implemented in a circuitry or software module.

In some example embodiments, the apparatus comprises means for receiving, from a distributed unit, DU, of the network device, an indication of a subset of data radio bearers, DRBs, configured for a small data transmission, SDT, for a terminal device; and means for transmitting, to the DU, a context request message including at least one DRB configured for the SDT to be setup corresponding to the received subset of DRBs.

In some example embodiments, the indication is transmitted in an Initial Uplink, UL, radio resource control, RRC, message transfer message. In some example embodiments, the indication is a part of assistance information within the Initial UL RRC message transfer message.

In some example embodiments, the context request message comprises at least one uplink tunnel endpoint identifier, TEID, for the subset of DRBs.

In some example embodiments, the apparatus further comprises means for receiving, from the DU, a context response message for setting up the subset of DRBs. In some example embodiments, the context response message comprises at least one downlink TEID for the subset of DRBs.

In some example embodiments, the apparatus further comprises means for transmitting, to a user plane, UP, of the CU, a further request for a bearer context modification, the further request comprising an indication of at least one of a list of DRBs to be resumed or a further list of DRBs to remain in a suspended state. In some example embodiments, the list of DRBs to be resumed comprises the received subset of DRBs. In some example embodiments, the list of DRBs to remain in a suspended state comprises DRBs configured for the SDT for the terminal device except the received subset of DRBs.

In some example embodiments, the apparatus further comprises means for performing other steps in some embodiments of the method 900. In some embodiments, the means comprises at least one processor and at least one memory including computer program code. The at least one memory and computer program code are configured to, with the at least one processor, cause the performance of the apparatus.

In some example embodiments, an apparatus capable of performing the method 1000 (for example, the UP 160 of the CU 140 of the network device 120) may comprise means for performing the respective steps of the method 1000. The means may be implemented in any suitable form. For example, the means may be implemented in a circuitry or software module.

In some example embodiments, the apparatus comprises means for receiving, from a control plane, CP, of the CU, a request for a bearer context modification, the request comprising an indication of at least one of a first list of data radio bearers, DRBs, to be resumed or a second list of DRBs to remain in a suspended state; and means for performing, based on the indication, a bearer context modification procedure to resume the first list of DRBs.

In some example embodiments, the first list of DRBs to be resumed or the second list of DRBs to remain in a suspended state contains DRBs previously configured as SDT DRBs for a terminal device.

In some example embodiments, the apparatus further comprises means for performing other steps in some embodiments of the method 1000. In some embodiments, the means comprises at least one processor and at least one memory including computer program code. The at least one memory and computer program code are configured to, with the at least one processor, cause the performance of the apparatus.

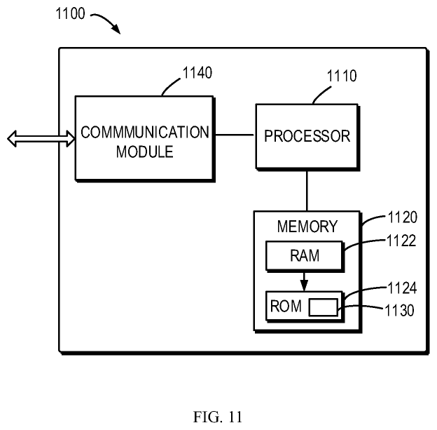

FIG. 11 illustrates a simplified block diagram of a device 1100 that is suitable for implementing some example embodiments of the present disclosure. The device 1100 may be provided to implement the communication device, for example, the terminal device 110, or the DU 130, CP 150 and UP 160 of the CU 140 of the network device 120 as shown in FIG. 1A. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has at least one antenna to facilitate communication. The communication interface may represent any interface that is necessary for communication with other network elements.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The program 1130 may be stored in the ROM 1124. The processor 1110 may perform any suitable actions and processing by loading the program 1130 into the RAM 1122.

The embodiments of the present disclosure may be implemented by means of the program 1130 so that the device 1100 may perform any process of the disclosure as discussed with reference to FIGS. 2 to 5. The embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. The computer readable medium may include any types of tangible non-volatile storage, such as ROM, EPROM, a flash memory, a hard disk, CD, DVD, and the like.

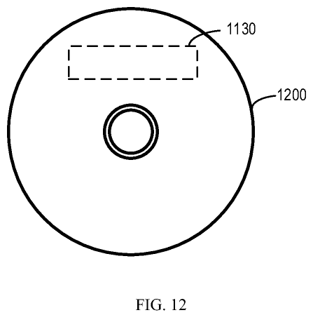

FIG. 12 illustrates a block diagram of an example of a computer readable medium 1200 in accordance with some example embodiments of the present disclosure. The computer readable medium 1200 has the program 1130 stored thereon. It is noted that although the computer readable medium 1200 is depicted in form of CD or DVD in FIG. 12, the computer readable medium 1200 may be in any other form suitable for carry or hold the program 1130.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 6-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A distributed unit of a network device, comprising:
at least one processor; and
at least one memory storing instructions that, when executed by the at least one processor, cause the distributed unit at least to:
determine that data for small data transmission from a terminal device is associated with a subset of data radio bearers configured for the small data transmission; and
transmit, to a control plane of a central unit of the network device, an indication of the subset of data radio bearers to be setup.

2. The distributed unit of claim 1, wherein the indication is transmitted in an initial uplink radio resource control message transfer message.

3. The distributed unit of claim 2, wherein the indication is a part of assistance information within the initial uplink radio resource control message transfer message.

4. The distributed unit of claim 1, wherein the distributed unit is further caused to:
receive, from the control plane of the central unit, a context request message for setting up the subset of data radio bearers.

5. The distributed unit of claim 4, wherein the context request message comprises at least one uplink tunnel endpoint identifier for the subset of data radio bearers.

6. The distributed unit of claim 4, wherein the distributed unit is further caused to:
transmit, to the control plane of the central unit, a context response message for setting up the subset of data radio bearers.

7. The distributed unit of claim 6, wherein the context response message comprises at least one downlink tunnel endpoint identifier for the subset of data radio bearers.

8. A control plane of a central unit of a network device, comprising:
at least one processor; and
at least one memory storing instructions that, when executed by the at least one processor, cause the control plane of the central unit at least to:
receive, from a distributed unit of the network device, an indication of a subset of data radio bearers configured for a small data transmission for a terminal device; and
transmit, to the distributed unit, a context request message including at least one data radio bearer configured for the small data transmission to be setup corresponding to the received subset of data radio bearers.

9. The control plane of the central unit of claim 8, wherein the indication is transmitted in an initial uplink radio resource control message transfer message.

10. The control plane of the central unit of claim 9, wherein the indication is a part of assistance information within the initial uplink radio resource control message transfer message.

11. The control plane of the central unit of claim 8, wherein the context request message comprises at least one uplink tunnel endpoint identifier for the subset of data radio bearers.

12. The control plane of the central unit of claim 8, wherein the control plane of the central unit is further caused to:
receive, from the distributed unit, a context response message for setting up the subset of data radio bearers.

13. The control plane of the central unit of claim 12, wherein the context response message comprises at least one downlink tunnel endpoint identifier for the subset of data radio bearers.

14. The control plane of the central unit of claim 8, wherein the control plane of the central unit is further caused to:
transmit, to a user plane of the central unit, a further request for a bearer context modification, the further request comprising an indication of at least one of a list of data radio bearers to be resumed or a further list of data radio bearers to remain in a suspended state.

15. The control plane of the central unit of claim 14, wherein the list of data radio bearers to be resumed comprises the received subset of data radio bearers.

16. The control plane of the central unit of claim 14, wherein the list of data radio bearers to remain in a suspended state comprises data radio bearers configured for the small data transmission for the terminal device except the received subset of data radio bearers.

17. A user plane of a central unit of a network device, comprising:
at least one processor; and
at least one memory storing instructions that, when executed by the at least one processor, cause the user plane of the central unit at least to:
receive, from a control plane of the central unit, a request for a bearer context modification, the request comprising an indication of at least one of a first list of data radio bearers to be resumed or a second list of data radio bearers to remain in a suspended state; and
perform, based on the indication, a bearer context modification procedure to resume the first list of data radio bearers.

18. The user plane of the central unit of claim 17, wherein the first list of data radio bearers to be resumed or the second list of data radio bearers to remain in a suspended state contains data radio bearers previously configured as small data transmission data radio bearers for a terminal device.
